(19) United States
(12) Patent Application Publication
(10) Pub. No.: US 2007/0278337 A1
(43) Pub. Date: Dec. 6, 2007

(54) Reel and mold for molding the reel

(75) Inventor: Shozo Onmori, Odawara-shi (JP)

Correspondence Address: SUGHRUE MION, PLLC, 2100 PENNSYLVANIA AVENUE, N.W., SUITE 800, WASHINGTON, DC, 20037, US

(73) Assignee: FUJIFILM Corporation, Minato-ku (JP)

(21) Appl. No.: 11/790,170

(22) Filed: Apr. 24, 2007

(30) Foreign Application Priority Data
Apr. 24, 2006 (JP) 2006-119600

(51) Int. Cl. G11B 23/113; G11B 23/037

(52) U.S. Cl. 242/324

(57) ABSTRACT

A reel around which recording tape is wound includes: a bottomed, circular cylinder-shaped hub; a reel plate that is disposed on a bottom surface of the hub; and plural gates that are disposed at equidistant intervals along the circumferential direction of the reel plate outside the reel plate and which serve as injection openings for a resin material during molding. An outer peripheral surface of the hub is formed along a circumference whose center coincides with an axial center portion of the hub, and with respect to the thickness of the hub, portions P positioned on straight lines connecting the axial center portion of the hub and the gates are the thinnest, and portions R positioned on straight extension lines that extend in the radial direction from the axial center portion of the hub and run orthogonal to straight lines connecting adjacent gates are the thickest.

### CROSS-REFERENCE TO RELATED APPLICATION

This application claims priority under 35 USC 119 from Japanese Patent Application No. 2006-119600, the disclosure of which is incorporated by reference herein.

### BACKGROUND OF THE INVENTION

1. Field of the Invention

The present invention relates to a reel that winds recording tape such as magnetic tape and to a mold for molding the reel.

2. Description of the Related Art

As external storage media for computers and the like, recording tape cartridges that include a case housing a reel onto which, for example, magnetic tape is wound are known. The reel includes a hub, which configures the axial center portion of the reel and onto whose outer periphery the magnetic tape is wound, and an upper flange and a lower flange, which project outward in the radial direction from both axial line direction ends of the hub.

Conventionally, a recording tape cartridge has been known which includes a single reel onto which is wound recording tape such as magnetic tape used as a data recording and playback medium for computers and the like, and the reel is rotatably housed inside a case made of synthetic resin. A leader member, such as a leader pin, leader tape, or a leader block, is disposed on the distal end (free end) of the recording tape, and pullout means disposed in a drive device pulls out the leader member from an opening in the recording tape cartridge so that the recording tape fixed to the pullout member is wound onto a take-up reel in the drive device.

Further, an annular reel plate magnetically attractable to a rotating shaft of the drive device is disposed on the bottom surface of the hub, and the reel is rotated by driving force from the rotating shaft in a state where the rotating shaft is magnetically attracted to the reel plate.

In the reel of such a recording tape cartridge, the recording tape is ordinarily wound around the outer peripheral surface of the hub. The height position of the recording tape in the vertical direction is regulated by the upper and lower flanges disposed on the top and bottom of the hub, the recording tape is retained such that its wound form is good, its running stability improves, and excessive damage is prevented when the recording tape is not in use.

Incidentally, because there is an annular plate in the axial center portion of the hub, gates serving as injection openings for resin when molding the hub cannot be disposed in the axial center portion of the hub (e.g., Japanese Patent Application Publication No. 2005-196876). For this reason, the gates are disposed outside the plate, but in the case of an annular body such as a hub, it is common to dispose gates at plural points (multipoint gates) along the circumferential direction.

However, in the case of multipoint gates, due to constriction after molding, the roundness of the hub drops, and with 3-point gates, as shown in FIG. 9, the hub becomes a substantially triangular shape (indicated by the dotted line) when seen in plan view. When recording tape is wound around an outer peripheral surface 210A of a hub 210 having a substantially triangular shape in this manner, the recording tape is wound around so as to form a circumscribed circle with respect to the outer peripheral surface 210A of the hub 210, so a gap arises between the recording tape and each edge of the substantial triangle, and in a high-temperature high-humidity environment, the gap portions become hot, the edges of the recording tape become wrinkled, and the signal becomes erratic.

### SUMMARY OF THE INVENTION

In view of these circumstances, it is an object of the present invention to obtain a reel that can ensure the roundness of a hub even with multipoint gates and a mold for forming the reel.

In order to achieve this object, a first aspect of the invention provides a reel including: a bottomed, circular cylinder-shaped hub around which recording tape is wound; a reel plate that is disposed on a bottom surface of the hub and is magnetically attractable to a rotating shaft of a drive device; and plural gates that are disposed at equidistant intervals along the circumferential direction of the reel plate outside the reel plate and which serve as injection openings for a resin material during molding, wherein an outer peripheral surface of the hub is formed along a circumference whose center coincides with an axial center portion of the hub, and with respect to the thickness of the hub, portions P positioned on straight lines connecting the axial center portion of the hub and the gates are the thinnest, and portions R positioned on straight extension lines that extend in the radial direction from the axial center portion of the hub and run orthogonal to straight lines connecting adjacent gates are the thickest, so that the thickness of the hub gradually changes toward the portions R.

In molded parts, pressure is greatest in the vicinity of the gates, and the pressure gradually becomes smaller away from the gates. For this reason, when plural gates (injection portions) are disposed along the circumferential direction of the reel plate, pressure is smallest at the center portions of straight lines connecting adjacent gates in the circumferential direction of the hub, so that due to constriction after molding, these portions constrict the most and a substantially polygonal hub is formed where the gate vicinities are the apexes.

Consequently, in the first aspect of the invention, the thickness of the hub is gradually changed in the circumferential direction of the hub. Specifically, the outer peripheral surface of the hub is formed coaxially along a circumference whose center coincides with the axial center portion of the hub, the thickness of the hub is thinner at positions corresponding to the apexes (portions P positioned on straight lines connecting the axial center portion of the hub and the gates (injection portions)) of the substantially polygonal shape, and the thickness of the hub becomes thicker at positions corresponding to the edges (portions R positioned on straight extension lines that extend in the radial direction from the axial center portion of the hub and run orthogonal to straight lines connecting adjacent gates) of the substantially polygonal shape.

That is, by gradually thickening the thickness away from the gates, the flow velocity is dropped and the pressure is raised. Thus, constriction of the hub is deterred and the roundness of the hub is obtained. Consequently, according to the present invention, a reel that can ensure the roundness of a hub can be obtained even with multipoint gates.

A second aspect of the invention provides a mold for molding a reel disposed with a bottomed, circular cylinder-shaped hub around which recording tape is wound and a reel plate that is disposed on a bottom surface of the hub and is magnetically attractable to a rotating shaft of a drive device, wherein plural gates positioned at equidistant intervals along the circumferential direction of the reel plate outside the reel plate and which serve as injection openings for a resin material during molding are disposed, and a space for forming the hub is configured to include an outer peripheral surface of the hub along a circumference whose center coincides with an axial center portion of the hub, and an inner peripheral surface of the hub where portions P positioned on straight lines connecting the axial center portion of the hub and the gates are the thinnest, and portions R positioned on straight extension lines that extend in the radial direction from the axial center portion of the hub and run orthogonal to straight lines connecting adjacent gates are the thickest, so that the thickness of the inner peripheral surface of the hub gradually changes toward the portions R.

By molding the reel with the mold of the second aspect, effects that are substantially the same as the effects of the invention of the first aspect can be obtained.

Because the invention is configured as described above, it can ensure the roundness of a hub even with multipoint gates.

### BRIEF DESCRIPTION OF THE DRAWINGS

FIG. 1A is a schematic perspective view of a recording tape cartridge as seen from above, and FIG. 1B is a schematic perspective view of the recording tape cartridge as seen from below;

FIG. 2 is a schematic cross-sectional view when a reel of the recording tape cartridge pertaining to an exemplary embodiment of the invention is in a rotation lock position;

FIG. 3 is a schematic cross-sectional view when the reel of the recording tape cartridge pertaining to the exemplary embodiment of the invention is in a rotation allowance position;

FIG. 4 is a schematic exploded perspective view of the reel of the recording tape cartridge pertaining to the exemplary embodiment of the invention, a brake member, and a rotating shaft of a drive device as seen from above;

FIG. 5 is a schematic exploded perspective view of the reel of the recording tape cartridge pertaining to the exemplary embodiment of the invention, the brake member, and the rotating shaft of the drive device as seen from below;

FIG. 6A is a schematic plan view showing a state where a clutch member is attached to the reel, and FIG. 6B is a schematic cross-sectional view showing a state where the clutch member is attached to the reel;

FIG. 7 is a schematic cross-sectional view showing a mold for molding a reel hub of the recording tape cartridge pertaining to the exemplary embodiment of the invention;

FIG. 8 is a bottom view showing the reel hub of the recording tape cartridge pertaining to the exemplary embodiment of the invention; and

FIG. 9 is an explanatory diagram showing a conventional reel hub.

### DETAILED DESCRIPTION OF THE INVENTION

A drive device pertaining to an exemplary embodiment of the present invention will be described below on the basis of the drawings, but first a recording tape cartridge (magnetic tape cartridge) 10 that is loadable into the drive device will be described. For the convenience of description, arrow A will represent the direction in which the recording tape cartridge 10 is loaded into the drive device and be referred to as a front direction (front side) of the recording tape cartridge 10.

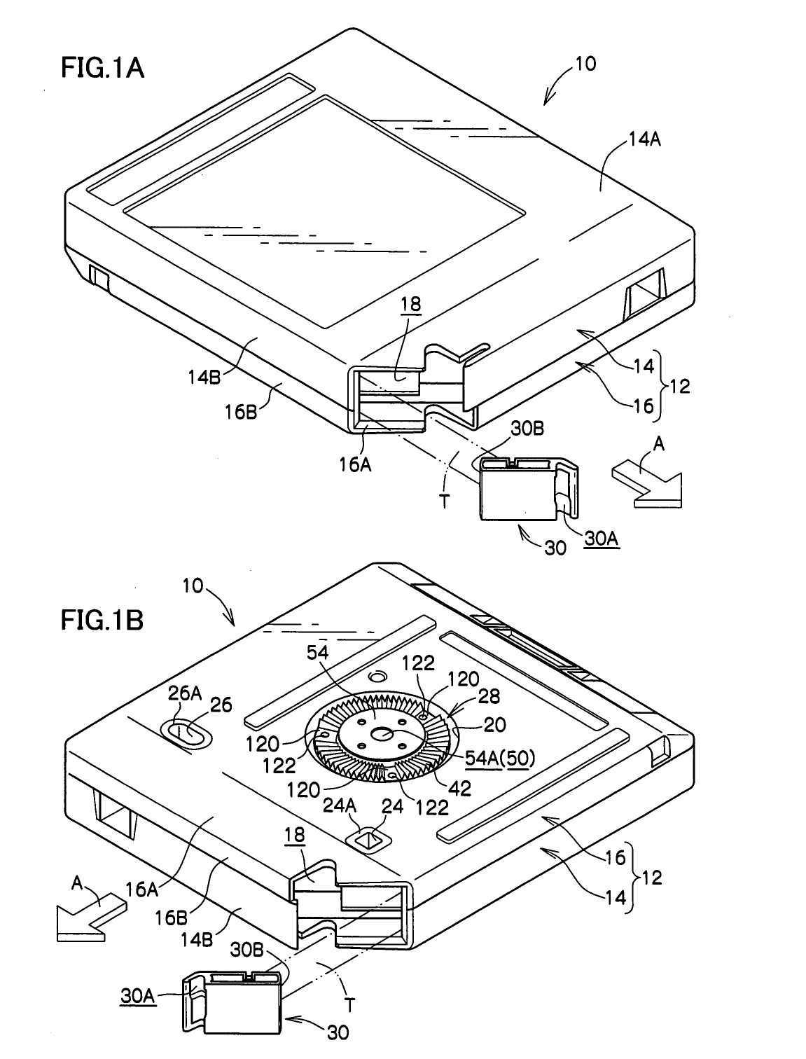

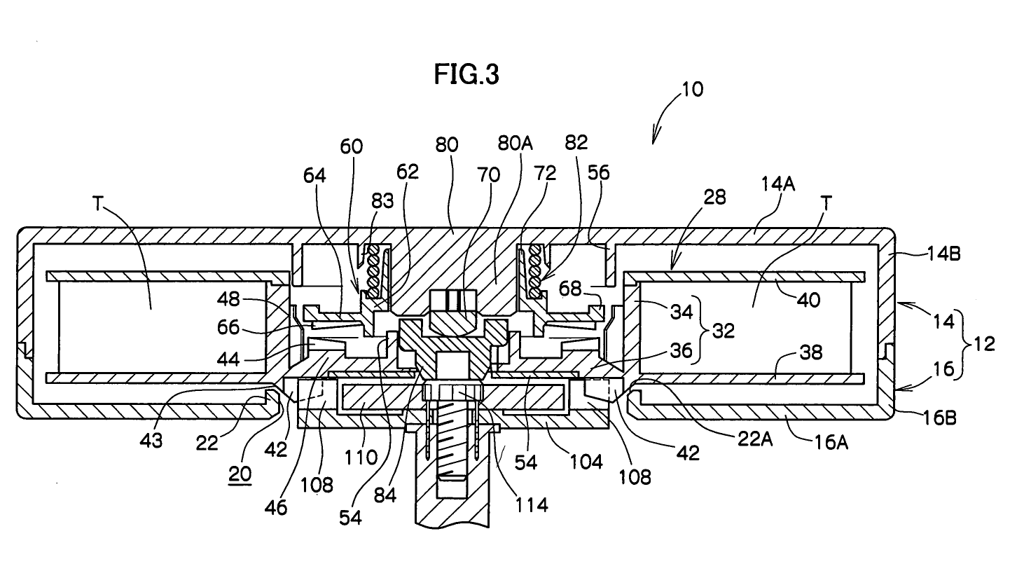

As shown in FIG. 1A and FIG. 3, the recording tape cartridge 10 includes a case 12. The case 12 is configured by joining together an upper case 14 and a lower case 16. Specifically, the upper case 14 is configured by disposing a substantially frame-like peripheral wall 14B upright along the outer edge of a top plate 14A that has a substantially rectangular shape when seen in plan view. The lower case 16 is configured by disposing a peripheral wall 16B upright along the outer edge of a bottom plate 16A that has a shape substantially corresponding to the shape of the top plate 14A. The case 12 is formed in a substantially box-like shape when the upper case 14 and the lower case 16 are joined together by ultrasonic welding or with screws in a state where the open end of the peripheral wall 14B and the open end of the peripheral wall 16B are brought into contact with each other.

An opening 18 that slants with respect to the loading direction is formed in the case 12 by cutting out corner portions of the top plate 14A, the peripheral wall 14B, the bottom plate 16A, and the peripheral wall 16B at the front side in the direction in which the recording tape cartridge 10 is loaded into the drive device. A circular gear opening 20 that penetrates the bottom plate 16A is disposed in the substantially center portion of the bottom plate 16A and serves to expose a later-described reel gear 42. An annular rib 22 is disposed on the edge portion of the gear opening 20 in the bottom plate 16A so as to project inside the case 12 and serves for positioning a later-described reel 28 and dust prevention.

A pair of positioning holes 24 and 26 is formed in the outer surface of the bottom plate 16A in the vicinity of the front end of the case 12. The two positioning holes 24 and 26 are disposed sac-like inside projecting portions (not shown) disposed so as to project inside the case 12 from the bottom plate 16A, and are arranged apart from each other on a hypothetical line orthogonal to the loading direction. The positioning hole 24 near the opening 18 has a substantially square shape when seen in bottom view that circumscribes a positioning pin of the drive device. The positioning hole 26 is an elongate hole that is long along the hypothetical line and whose width corresponds to the diameter of a positioning pin. Consequently, when the recording tape cartridge 10 is loaded into the drive device and the positioning pins are respectively inserted into the positioning holes 24 and 26, the recording tape cartridge 10 is accurately positioned in the horizontal direction (left and right, front and back) inside the drive device.

Moreover, surfaces around the positioning holes 24 and 26 in the bottom plate 16A serve as positioning surfaces 24A and 26A that are finished more smoothly than the other portion (design surface). The positioning surfaces 24A and 26A are configured to contact positioning surfaces of the drive device disposed around the positioning pins when the positioning pins are inserted into the positioning holes 24 and 26. Thus, the recording tape cartridge 10 is positioned in the vertical direction inside the drive device.

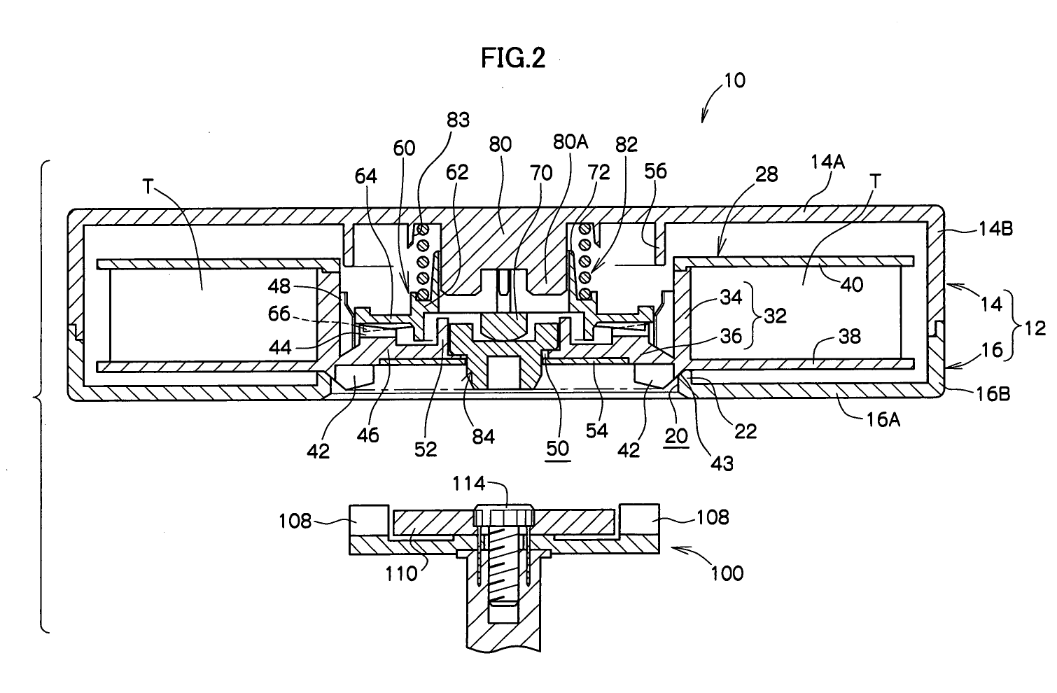

As shown in FIG. 2, just one reel 28 which will be described later is rotatably housed inside the above-described case 12. Magnetic tape T serving as recording tape is wound onto the reel 28, and a leader block 30 serving as a pullout member is attached to the distal end of the magnetic tape T. The leader block 30 is housed and retained inside the opening 18 in the case 12 when the recording tape cartridge 10 is not in use. In this state, the leader block 30 closes the opening 18 and prevents the ingress of dust and the like into the case 12.

An engagement concave portion 30A is formed in the distal end of the leader block 30. When the magnetic tape T is to be pulled out inside the drive device, the leader block 30 is extracted from the case 12 by pullout means that engage with the engagement concave portion 30A and is guided to a take-up reel (not shown) of the drive device. The end surface of the leader block 30 on the opposite side of the engagement concave portion 30A serves as a circularly arced surface 30B and is fitted into the take-up reel to configure part of a take-up surface that takes up the magnetic tape T.

Next, the reel 28 will be described.

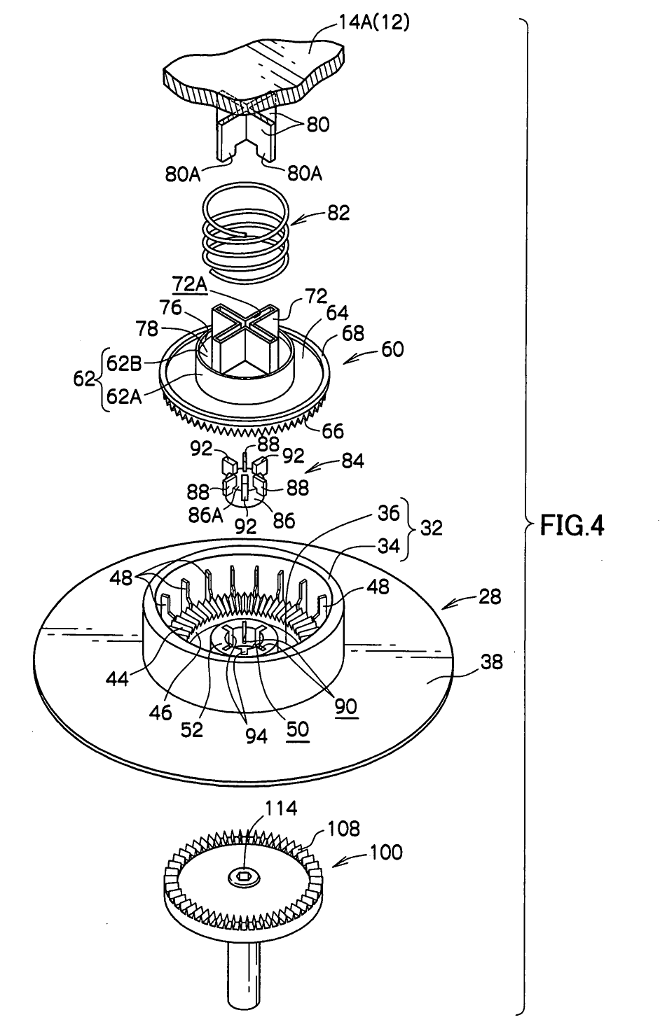

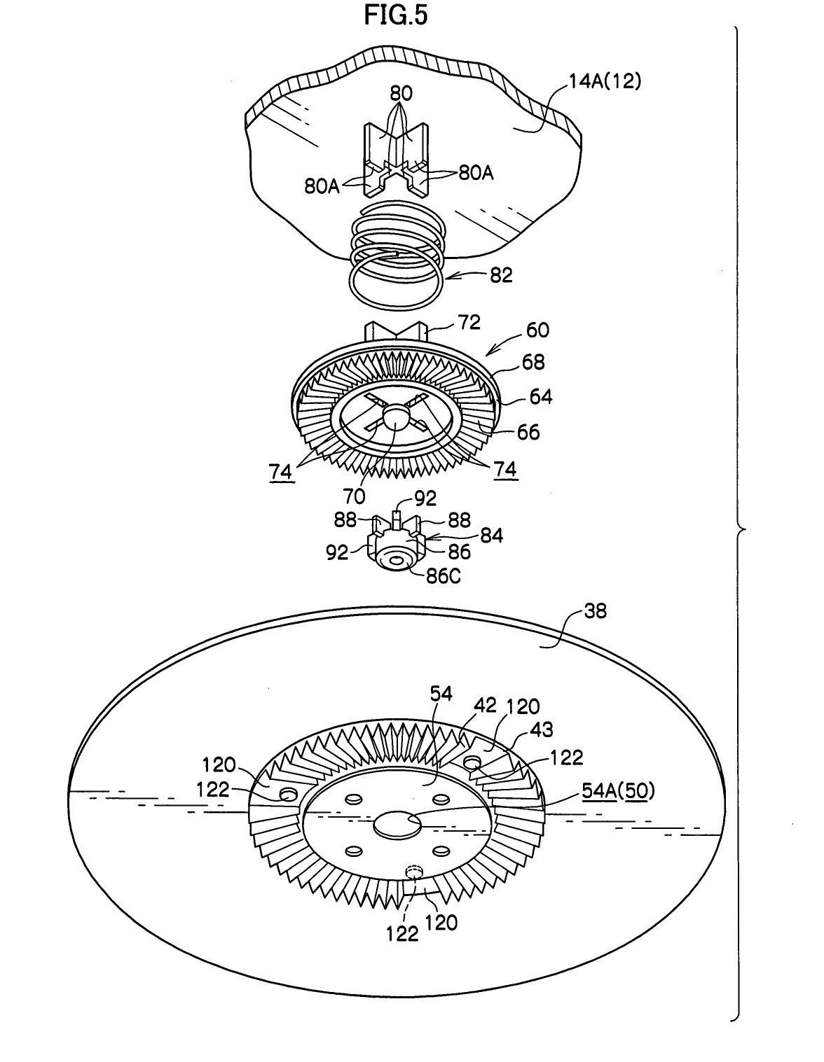

As shown in FIG. 4 and FIG. 5, the reel 28 includes a reel hub 32 that configures the axial center portion of the reel 28. The reel hub 32 is formed in a substantially bottomed circular cylinder shape that includes a circular cylinder portion 34 onto whose outer peripheral surface the magnetic tape T is wound and a bottom portion 36 that closes the bottom portion of the circular cylinder portion 34. A lower flange 38 is coaxially and integrally disposed in the vicinity of the bottom portion 36 side end portion (lower end portion) of the reel hub 32 so as to extend outward in the radial direction of the reel hub 32.

An annular upper flange 40 of the same diameter as the outer diameter of the lower flange 38 is fixedly attached by ultrasonic welding to the upper end portion of the circular cylinder portion 34 so as to be coaxial with the reel hub 32. That is, the reel 28 is configured such that the magnetic tape T is wound around the outer peripheral surface of the circular cylinder portion 34 of the reel hub 32 between the opposing surfaces of the lower flange 38 and the upper flange 40.

An annular reel gear 42 formed coaxially with the reel 28 is disposed in the vicinity of the outer periphery of the undersurface (outer surface) of the bottom portion 36 of the reel hub 32. The reel gear 42 is configured to be meshable with a drive gear 108 disposed on the distal end of a rotating shaft 100 of the drive device.

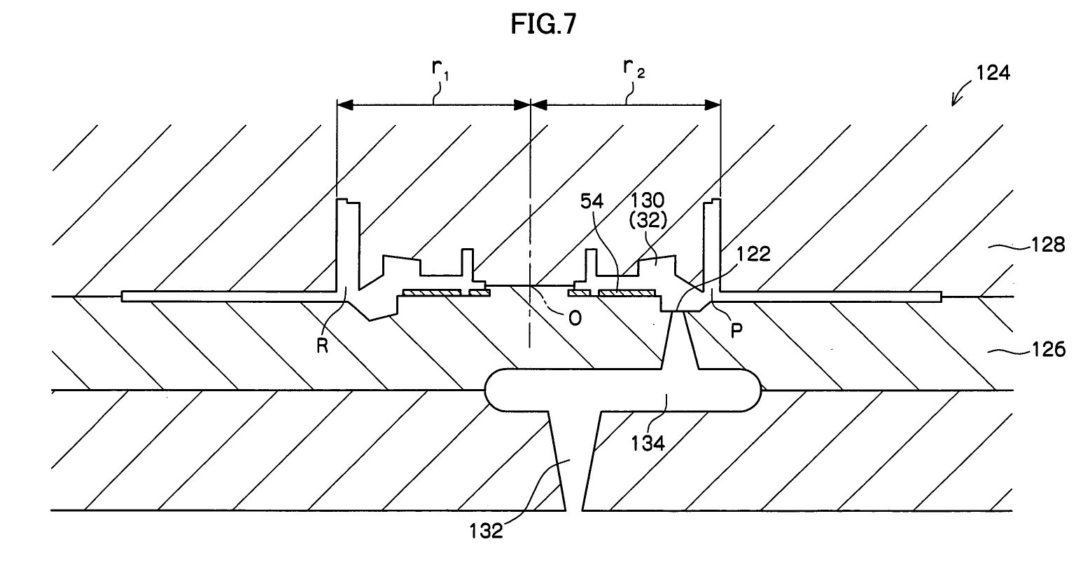

Rectangular recessed portions 120 are formed in the reel gear 42 at intervals of 120° along the circumferential direction, and gates 122 (described later) are disposed in the upper surfaces of the recessed portions 120. In FIG. 7, there is shown a state where a mold 124 for molding the reel hub 32 is clamped. The reel hub 32 is molded by filling the inside of a cavity 130 configured by a fixed template 126 and a movable template 128 with a resin material, and the gates 122 are entrances into the cavity 130.

A resin material ejected from a molding machine (not shown) passes through the three gates 122 disposed in the reel gear 42 via a flow path (a sprue 132 and a runner 134) formed in the fixed template 126 and is injected into the cavity 130. Then, when the cavity 130 is filled, the resin material cools, and thereafter the mold 124 is opened and the reel hub 32 is removed from the mold 124.

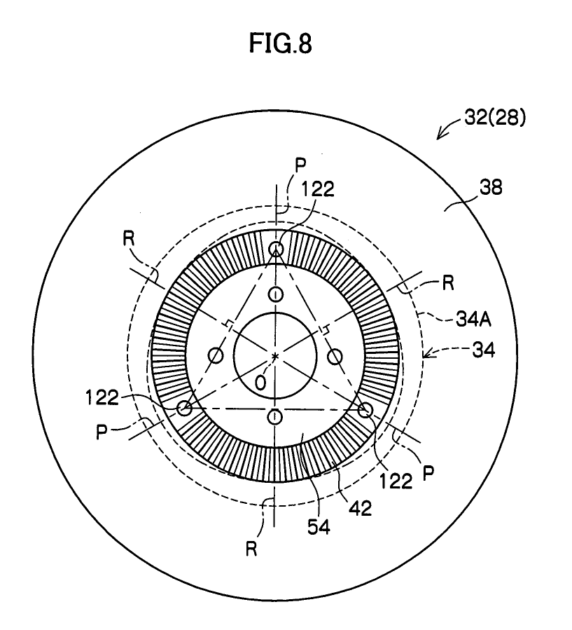

Here, as shown in FIG. 8, in the circular cylinder portion 34 of the reel hub 32, an outer peripheral surface 34A of the circular cylinder portion 34 is formed coaxially with respect to the axial center portion O of the reel hub 32, the thickness of portions P positioned on straight lines connecting the axial center portion O of the circular cylinder portion 34 and the gates 122 is made the thinnest, and the thickness of portions R positioned on straight extension lines that extend from the axial center portion O of the circular cylinder portion 34 and run orthogonal to straight lines connecting adjacent gates 122 is made the thickest, so that the thickness of the circular cylinder portion 34 is gradually changed.

As shown in FIG. 4 and FIG. 5, an annular engagement gear 44 formed coaxially with the reel 28 is disposed in the vicinity of the outer periphery of the upper surface (inner surface) of the bottom portion 36 of the reel hub 32. The engagement gear 44 is formed on an annular pedestal portion 46 slightly raised from the inner surface of the bottom portion 36 and is configured to be meshable with a braking gear 66 of a later-described brake member 60.

Further, upright ribs 48 continuing from the inner surface of the circular cylinder portion 34 and the upper surface of the bottom portion 36 along the axial line direction of the reel 28 are plurally disposed at equidistant intervals in the circumferential direction outside the engagement gear 44 (the pedestal portion 46) in the radial direction. Because of the presence of the upright ribs 48, the engagement gear 44 is positioned further inward in the radial direction than the reel gear 42.

Moreover, a through hole 50 is disposed in the axial center portion of the bottom portion 36 of the reel hub 32. A clutch-use boss portion 52 is disposed along the edge portion of the through hole 50 upright from the upper surface of the bottom portion 36. The clutch-use boss portion 52 will be described together with a later-described clutch member 84.

The portions of the above-described reel 28 excluding the upper flange 40 are integrally formed by resin. Additionally, an annular reel plate 54 configured by a magnetic material is coaxially and integrally disposed, by insert molding, inside the reel gear 42 on the undersurface of the bottom portion 36 of the reel hub 32.

The reel 28 is housed in the case 12 and rested on the annular rib 22 when not in use. Specifically, the outside portion (in the vicinity of the inner edge of the lower flange 38) of a tapered portion 43 of the bottom portion 36 contacts the upper end surface of the annular rib 22, and the inner edge portion of the upper end of the annular rib 22 serves as a tapered surface 22A corresponding to the tapered portion 43, so that movement of the reel 28 in the radial direction is regulated. Additionally, the ingress of dust and the like from there is deterred.

In this state, the reel 28 is positioned inside the case 12 overall, and the reel gear 42 and the reel plate 54 is exposed from the gear opening 20 (see FIG. 1B). That is, the reel gear 42 is exposed to the outside of the case 12 from the gear opening 20 but does not project from the outer surface (undersurface) of the bottom plate 16A. Further, the through hole 50 is exposed to the gear opening 20 through a clear hole 54A in the reel plate 54.

Thus, operation of the reel 28—that is, chucking (holding) and rotational driving—from the outside of the case 12 is enabled. Further, in this state, an annular regulation rib 56 disposed upright from the top plate 14A enters the upper portion of the circular cylinder portion 34 of the reel 28. The outer peripheral surface of the regulation rib 56 is proximate to the inner edge portion of the upper flange 40, and the regulation rib 56 regulates movement of the reel 28 in the horizontal direction inside the case 12.

The recording tape cartridge 10 also includes a brake member 60 for inhibiting rotation of the reel 28 when the recording tape cartridge 10 is not in use. The brake member 60 includes a base portion 62, and the base portion 62 is formed in a substantially bottomed circular cylinder shape that opens downward by a cylinder portion 62A formed in a short circular cylinder shape and a circular plate portion 62B that closes the upper end of the cylinder portion 62A. The outer diameter of the cylinder portion 62A is smaller than the inner diameter of the engagement gear 44 (the pedestal portion 46), and the inner diameter of the cylinder portion 62A is larger than the outer diameter of the clutch-use boss portion 52.

A ring portion 64 formed in an annular shape is disposed so as to extend outward in the radial direction across the entire circumference of the base portion 62 from the axial line direction intermediate portion of the outer peripheral portion of the base portion 62 (the cylinder portion 62A). A braking gear 66 is disposed across the entire circumference of the ring portion 64 on the undersurface of the ring portion 64. That is, the braking gear 66 is formed in an annular shape overall. The braking gear 66 is configured to be meshable with the engagement gear 44 of the reel 28.

The inner end portions of the teeth configuring the braking gear 66 are coupled together by the cylinder portion 62A, and the outer end portions of the teeth that are in a free state are positioned slightly farther inside in the radial direction than the outer edge of the ring portion 64. In other words, the ring portion 64 projects farther outward in the radial direction than the braking gear 66. More specifically, the outer diameter of the ring portion 64 is slightly larger than the outer diameter of the engagement gear 44, and the outer diameter of the braking gear 66 is slightly smaller than the outer diameter of the engagement gear 44. Moreover, an annular reinforcement rib 68 is disposed upright on the upper surface of the ring portion 64 along the outer edge portion of the ring portion 64, so that the rigidity of the ring portion 64 (the braking gear 66) is ensured.

A slide-contact projecting portion 70 is disposed so as to project from the axial center portion of the undersurface (inside the cylinder portion 62A) of the circular plate portion 62B of the base portion 62. The distal end portion of the slide-contact projecting portion 70 is formed in a substantially spherical shape and configured to substantially point-contact the later-described clutch member 84. The distal end of the slide-contact projecting portion 70 is positioned just barely higher (inside the cylinder portion 62A) than the lower end surface of the cylinder portion 62A. A cross-shaped projection 72, in the inside of which is formed an insertion groove 72A formed in a substantial cross shape when seen in plan view, is disposed upright from the upper surface of the circular plate portion 62B. Further, through holes 74 that penetrate the circular plate portion 62B in its plate thickness direction are disposed in the circular plate portion 62B.

The through holes 74 are divided into four, with each being formed in a rectangular shape, so as to communicate with the radial direction outside portions, excluding the axial center portion (which is the intersection portion), of the insertion groove 72A formed in a cross shape when seen in plan view. Thus, each of the through holes 74 is positioned adjacent to the radial direction outer side of the slide-contact projecting portion 70 and opens to the inside of the cylinder portion 62A. Further, an annular rib 76 is disposed upright on the outer peripheral portion of the upper end of the base portion 62, and the upper surface of the circular plate portion 62B between the rib 76 and the cross-shaped projection 72 serves as a spring receiving surface 78 that one end portion of a later-described compression coil spring 82 contacts.

The above-described brake member 60 is inserted substantially coaxially inside the circular cylinder portion 34 of the reel hub 32 so as to be movable in the vertical direction (axial line direction of the reel 28). That is, by moving in the vertical direction, the brake member 60 can assume a position where the braking gear 66 meshes with the engagement gear 44 of the reel hub 32 (rotation lock position) and a position where the braking gear 66 disengages from the engagement gear 44 (rotation allowance position).

A cross-shaped rib 80 disposed projecting downward from the top plate 14A of the case 12 enters the insertion groove 72A in the cross-shaped projection 72 of the brake member 60. The cross-shaped rib 80 has a detent form configured as a form where two thin plate pieces intersect so as to be orthogonal to each other, and the cross-shaped rib 80 engages with the cross-shaped projection 72 (the groove walls of the insertion groove 72A) to deter rotation of the brake member 60 with respect to the case 12. Consequently, the brake member 60 deters rotation of the reel 28 in a state where the braking gear 66 is caused to mesh with the engagement gear 44 of the reel hub 32.

It will be noted that the cross-shaped rib 80 is configured such that the state where it has entered the insertion groove 72A is maintained across the entire moving stroke of the brake member 60 in the vertical direction, so that the cross-shaped rib 80 also fulfills the function of guiding the movement of the brake member 60 in the vertical direction. Moreover, the cross-shaped rib 80 includes projecting pieces 80A disposed so as to extend from positions on its lower end portion corresponding to the through holes 74 in the brake member 60. The width (length in the radial direction of the brake member 60) of each of the projecting pieces 80A is narrowed in correspondence to the longitudinal dimension of each of the through holes 74, so that the projecting pieces 80A can enter respectively different through holes 74.

Further, the projecting pieces 80A are positioned inside the insertion groove 72A when the brake member 60 is positioned in the rotation lock position, and the projecting pieces 80A enter the through holes 74 and project from the undersurface of the circular plate portion 62B when the brake member 60 is positioned in the disengaged position (rotation allowance position). Thus, because the projecting pieces 80A are extendedly disposed, the cross-shaped rib 80 not only deters rotation of the brake member 60 with respect to the case 12 but also significantly increases the amount it engages with the brake member 60 (insertion depth) to control slanting of the brake member 60 with respect to the case 12. Further, the cross-shaped rib 80 of this configuration improves the guidability of the brake member 60 in the vertical direction. It will be noted that, in the present exemplary embodiment, the amount that the cross-shaped rib 80 including the projecting pieces 80A engages in the axial line direction with the brake member 60 positioned in the rotation lock position is set to be sufficiently larger than the entire moving stroke of the brake member 60.

Further, the brake member 60 is configured such that its movement in the radial direction is regulated by the upright ribs 48 of the reel 28 when the brake member 60 is positioned in the rotation lock position and so that there is no potential for the brake member 60 to interfere with the upright ribs 48 that rotate together with the reel 28 when the brake member 60 is positioned in the rotation allowance position. For this reason, the upright ribs 48 are positioned proximate to the reinforcement rib 68 of the ring portion 64 of the brake member 60 positioned in the rotation lock position, and the upper portions of the upright ribs 48 are cut out so that the distance between the upright ribs 48 and the reinforcement rib 68 of the brake member 60 positioned in the rotation allowance position is equal to or greater than a predetermined value. Thus, not only is movement of the reel 28 directly regulated in the case 12, but movement of the reel 28 in the radial direction with respect to the case 12 is regulated via the brake member 60 in the vicinity of the position of the center of gravity of the reel 28, so that the reel 28 is configured to also be stably loadable into an upright (where the axial line of the reel 28 is in the horizontal direction) drive device.

Further, a compression coil spring 82 is disposed between the spring receiving surface 78 of the brake member 60 and the top plate 14A. One end portion of the compression coil spring 82 contacts the spring receiving surface 78, and the other end portion of the compression coil spring 82 contacts the top plate 14A. The other end portion of the compression coil spring 82 is positioned inside an annular wall portion 83 disposed so as to project from the top plate 14A outside the cross-shaped rib 80, so that the compression coil spring 82 does not become displaced in the radial direction.

The brake member 60 is biased downward by the biasing force of the compression coil spring 82, so that ordinarily the braking gear 66 is caused to mesh with the engagement gear 44 to reliably prevent inadvertent rotation of the reel 28 (the brake member 60 is caused to be positioned in the rotation lock position). Further, the reel 28 meshing with the brake member 60 at the engagement gear 44 is also biased downward by this biasing force and brought into contact with the annular rib 22 so that the reel 28 does not rattle inside the case 12.

The recording tape cartridge 10 also includes a clutch member 84 that is operated from the outside to release the reel 28 from the state where it is locked by the brake member 60. The clutch member 84 is disposed between the bottom portion 36 of the reel 28 and the brake member 60, and includes a clutch body 86 formed in a substantially circular column shape. The outer diameter of the clutch body 86 is slightly smaller than the inner diameter of the clear hole 54A in the reel plate 54—that is, the inner diameter of the through hole 50 that coincides with the inner diameter of the clutch-use boss portion 52.

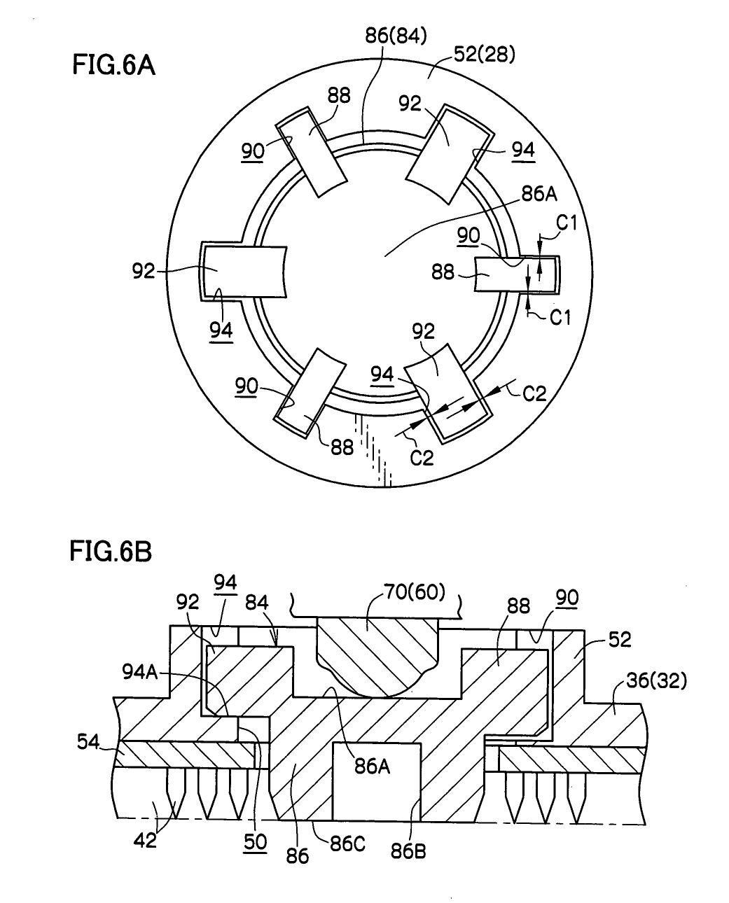

Moreover, as shown also in FIG. 6B, the flat axial center portion upper end surface of the clutch body 86 serves as a slide-contact surface 86A that always contacts the slide-contact projecting portion 70 of the brake member 60. Further, the flat lower end surface of the clutch body 86 around a bored hole 86B disposed opening downward serves as a press surface 86C. The clutch member 84 is configured such that when the press surface 86C is pressed, the clutch member 84 moves upward counter to the biasing force of the compression coil spring 82 to cause the brake member 60 to move to the rotation allowance position.

The clutch member 84 also includes rotation regulating ribs 88 that project further outward in the radial direction than the outer peripheral surface of the clutch body 86. The rotation regulating ribs 88 are plurally (three in the present embodiment) disposed at equidistant intervals in the circumferential direction of the clutch body 86 and are arranged radially when seen in plan view. Further, the rotation regulating ribs 88 project higher than the slide-contact surface 86A so as to straddle (be continuous with) the upper end surface of the clutch body 86 around the slide-contact surface 86A and the outer peripheral surface in the vicinity of that upper end surface.

The rotation regulating ribs 88 enter rotation regulating grooves 90 disposed recessed from the inner edge portion of the clutch-use boss portion 52. That is, three rotation regulating grooves 90 are disposed at equidistant intervals in the circumferential direction of the clutch-use boss portion 52. The rotation regulating grooves 90 open upward at the upper end of the clutch-use boss portion 52. Thus, the clutch member 84 is capable of moving in the vertical direction while being guided at its rotation regulating ribs 88 in the rotation regulating grooves 90 in the clutch-use boss portion 52.

Further, the rotation regulating ribs 88 are configured to maintain the state where they have entered the rotation regulating grooves 90 in the clutch-use boss portion 52 even when the clutch member 84 moves upward and causes the brake member 60 to be positioned in the rotation allowance position. Thus, the clutch member 84 is configured to be incapable of relative rotation with respect to the reel 28, that is, the clutch member 84 is configured to always rotate integrally with the reel 28.

Moreover, because the rotation regulating grooves 90 are closed at the lower end portion of the clutch-use boss portion 52, the clutch member 84 can also be prevented by the rotation regulating ribs 88 and the rotation regulating grooves 90 from falling out of the reel hub 32, but in the present exemplary embodiment, the clutch member 84 includes, separately from the rotation regulating ribs 88, seating ribs 92 that prevent the clutch member 84 from falling out of the reel hub 32.

The seating ribs 92 are plurally disposed at equidistant intervals in the circumferential direction of the clutch body 86. In the present embodiment, one seating rib 92 is disposed between each adjacent pair of rotation regulating ribs 88 in the circumferential direction, for a total of three seating ribs 92. Similar to the rotation regulating ribs 88, the seating ribs 92 project upward and outward in the radial direction so as to straddle the upper end surface of the clutch body 86 around the slide-contact surface 86A and the outer peripheral surface in the vicinity of that upper end surface, and are arranged radially when seen in plan view.

The seating ribs 92 are configured to enter stopper grooves 94 disposed recessed from the inner edge portion of the clutch-use boss portion 52. That is, the stopper grooves 94 are disposed at equidistant intervals in the circumferential direction of the clutch-use boss portion 52 and between each adjacent pair of rotation regulating grooves 90 in the circumferential direction. The stopper grooves 94 open upward at the upper end of the clutch-use boss portion 52, and the upper surfaces of bottom portions that close the lower end portions of the stopper grooves 94 serve as stopper surfaces 94A. The seating ribs 92 are configured such that the lower end surfaces of the seating ribs 92 contact (become seated on) the stopper surfaces 94A when the brake member 60 is in the rotation lock position.

Here, the clutch member 84 is integrally formed by integrally molding the clutch body 86, the rotation regulating ribs 88, and the seating ribs 92. Additionally, as shown in FIG. 6B, the heights of the upper end surfaces of each of the rotation regulating ribs 88 and each of the seating ribs 92 coincide, but the lower end surfaces of the rotation regulating ribs 88 are positioned lower than those of the seating ribs 92. Correspondingly, the upper ends of the rotation regulating grooves 90 and the stopper grooves 94 that open at the upper end of the clutch-use boss portion 52 coincide, but the bottom surfaces of the rotation regulating grooves 90 are positioned lower than the stopper surfaces 94A of the stopper grooves 94. In other words, the rotation regulating ribs 88 are longer in the vertical direction than the seating ribs 92, and the rotation regulating grooves 90 are deeper in the vertical direction than the stopper grooves 94.

The reason for this is, by enlarging the engageable amount between the rotation regulating ribs 88 and the clutch-use boss portion 52 (the amount that the rotation regulating ribs 88 can be inserted into the rotation regulating grooves 90), this alleviates stress received from the reel 28 during rotation of the reel 28, improves guidability when the clutch member 84 moves up and down, and controls rattling of the clutch member 84 even when the brake member 60 is caused to be positioned in the rotation allowance position.

Further, as shown in FIG. 6A, in order to further control this rattling, a clearance C1 on one circumferential direction side between the rotation regulating ribs 88 and the rotation regulating grooves 90 is set to be small to the extent that sliding resistance does not become excessive when the clutch member 84 moves up and down. Moreover, the rotation regulating ribs 88 are configured such that their thickness (thickness in the circumferential direction of the clutch member 84) is thinned in a range that does not become a problem in terms of strength and such that dimensional precision resulting from resin molding is high. For this reason, the clearance C1 can be made even smaller.

On the other hand, the seating ribs 92 are configured such that their thickness (thickness in the circumferential direction of the clutch member 84) is sufficiently larger than the thickness of the rotation regulating ribs 88. Thus, the seating ribs 92 are configured such that, when they contact the stopper surfaces 94A, sufficient rigidity is ensured with respect to the biasing force of the compression coil spring 82 acting via the brake member 60. Further, because the seating ribs 92 are thick, resin fluidity during molding is relatively poor, but it is difficult for them to be affected by poor fluidity because they are shorter than the rotation regulating ribs 88 as described above.

Moreover, the seating ribs 92, which are thickly formed and whose dimensional precision is inferior to that of the rotation regulating ribs 88, are configured such that the function of controlling rattling of the clutch member 84 is not demanded thereof, and a clearance C2 in the circumferential direction between the seating ribs 92 and the stopper grooves 94 is set to be sufficiently larger than the clearance C1. Thus, the seating ribs 92 are configured to either not cause sliding resistance when the clutch member 84 moves up and down or remarkably control sliding resistance.

Further, the heights (positions of the upper ends) of the rotation regulating ribs 88 and the seating ribs 92 are determined such that the rotation regulating ribs 88 and the seating ribs 92 do not interfere with the projecting pieces 80A of the case 12 penetrating the circular plate portion 62B of the brake member 60 when the clutch member 84 moves upward to cause the brake member 60 to be positioned in the rotation allowance position (see FIG. 3).

The clutch body 86 of the above-described clutch member 84 is inserted through the through hole 50 and the clear hole 54A in a state where the rotation regulating ribs 88 have been inserted into respectively different rotation regulating grooves 90 and the seating ribs 92 have been inserted into respectively different stopper grooves 94. Additionally, ordinarily the clutch member 84 is retained in a state where the seating ribs 92 are brought into contact with the stopper surfaces 94A by the biasing force of the compression coil spring 82 acting via the brake member 60.

In this state, the lower end surfaces of the rotation regulating ribs 88 are slightly separated from the bottom surfaces of the rotation regulating grooves 90 (see FIG. 6B), and the press surface 86C is positioned slightly higher (0.1 mm in the present exemplary embodiment) in the vertical direction than the tooth tips of the reel gear 42. Additionally, in accompaniment with the reel gear 42 meshing with the drive gear 108 of the drive device, the clutch member 84 is pressed by a release portion 114 of the drive device and moves upward.

Next, the action of the present exemplary embodiment will be described.

In the recording tape cartridge 10 of the above-described configuration, as shown in FIG. 2, when the recording tape cartridge 10 is not in use, the brake member 60 is positioned in the rotation lock position and the braking gear 66 is caused to mesh with the engagement gear 44 by the biasing force of the compression coil spring 82. For this reason, rotation of the reel 28 with respect to the case 12 is deterred. At this time, the reel gear 42 of the reel 28 is exposed from the gear opening 20, the clutch body 86 of the clutch member 84 is inserted through the penetration hole 50 and the clear hole 54A and is exposed from the gear opening 20.

When the magnetic tape T is to be used, as shown in FIG. 1B, the recording tape cartridge 10 is loaded into a bucket (not shown) of the drive device along the direction of arrow A. Then, when the recording tape cartridge 10 is loaded a predetermined depth into the bucket, the bucket lowers and the rotating shaft 100 of the drive device relatively moves toward (upward) the gear opening 20 in the case 12 and holds the reel 28. Specifically, the rotating shaft 100 uses a magnet 110 to magnetically attract and hold, without contacting, the reel plate 54, and causes the drive gear 108 to mesh with the reel gear 42.

In accompaniment with the meshing of the reel gear 42 and the drive gear 108, that is, the relative movement of the rotating shaft 100 in the axial direction toward the case 12, the release portion 114 of the rotating shaft 100 contacts the press surface 86C of the clutch member 84 and pushes the clutch member 84 upward counter to the biasing force of the compression coil spring 82. Thus, the brake member 60 contacting the clutch member 84 at its slide-contact projecting portion 70 also moves upward so that the braking gear 66 of the brake member 60 disengages from the engagement gear 44.

That is, the brake member 60 reaches a relative rotation allowance position with respect to the reel 28. Then, when the release portion 114 contacts the press surface 86C and the rotating shaft 100 relatively moves upward, the reel 28 is lifted upward together with the clutch member 84 and the brake member 60 (without their relative positions being changed), the brake member 60 reaches an absolute (with respect to the case 12) rotation allowance position, and the lower flange 38 separates from the annular rib 22 (the tapered surface 22A). Due to the above, the reel 28 rises inside the case 12 and becomes rotatable in a state of non-contact with the inner surface of the case 12.

Further, at this time, because of the lowering of the bucket—that is, the recording tape cartridge 10—inside the drive device, the positioning pins of the drive device respectively enter the positioning holes 24 and 26 in the case 12, and the positioning surfaces of the drive device contact the positioning surfaces 24A and 26A of the case 12. Thus, the recording tape cartridge 10 is positioned in the horizontal direction and the vertical direction with respect to the drive device.

When this happens, the pullout means of the drive device causes a pullout pin (not shown) to engage with the engagement concave portion 30A of the leader block 30 to extract the leader block 30 from the case 12 and guide the leader block 30 to the take-up reel of the drive device. Then, the leader block 30 is fitted into the take-up reel so that the circularly arced surface 30B configures part of the take-up surface that takes up the magnetic tape T.

When the leader block 30 rotates integrally with the take-up reel in this state, the magnetic tape T is pulled out from the case 12 through the opening 18 while being taken up onto a reel hub of the take-up reel. At this time, the reel 28 of the recording tape cartridge 10 rotates synchronously with the take-up reel due to the rotational force of the rotating shaft 100 transmitted by the drive gear 108 that meshes with the reel gear 42.

Then, information is recorded to the magnetic tape T, or information recorded on the magnetic tape T is played back, by a recording and playback head disposed along a predetermined tape path in the drive device. At this time, the slide-contact projecting portion 70 of the brake member 60 that is incapable of rotation with respect to the case 12 slidingly contacts the slide-contact surface 86A of the clutch member 84 that rotates together with the reel 28 with respect to the case 12.

When the magnetic tape T is to be rewound onto the reel 28 and the leader block 30 is to be retained in the vicinity of the opening 18 in the case 12, the bucket into which the recording tape cartridge 10 has been loaded is raised upward. When this happens, the drive gear 108 disengages from the reel gear 42, the release portion 114 moves out of contact with the slide-contact surface 86A of the clutch member 84, and the clutch member 84 moves downward together with the brake member 60 (such that their state of contact is maintained) because of the biasing force of the compression coil spring 82.

Thus, the seating ribs 92 of the clutch member 84 contact the stopper surfaces 94A, and the braking gear 66 of the brake member 60 meshes with the engagement gear 44. That is, the brake member 60 returns to the rotation lock position where it deters rotation of the reel 28 with respect to the case 12. Further, in accompaniment with the brake member 60 and the clutch member 84 moving because of the biasing force of the compression coil spring 82, the reel 28 also moves downward and returns to its initial state where its lower flange 38 contacts the annular rib 22 and the reel gear 42 is exposed from the gear opening 20. In this state, the recording tape cartridge 10 is ejected from the bucket.

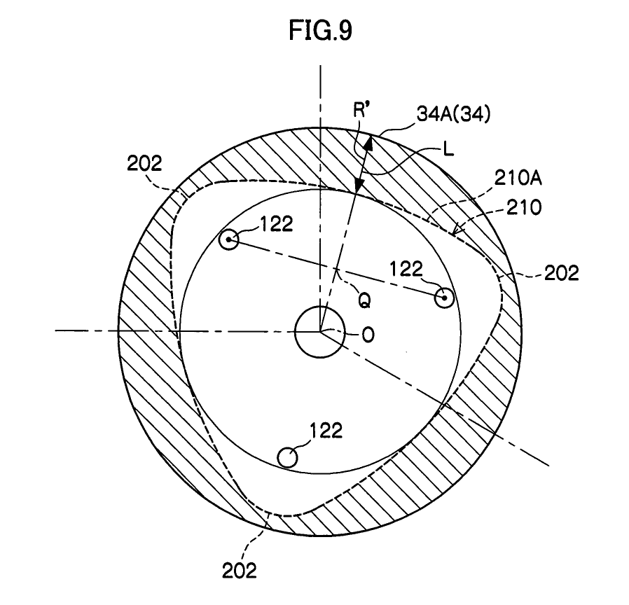

Incidentally, in molded parts, usually pressure is greatest in the vicinity of the gates for injecting the resin material into the mold, and the pressure gradually becomes smaller away from the gates. For this reason, as shown in FIG. 8, when the plural gates 122 are disposed along the circumferential direction of the reel plate 54, then as shown in FIG. 9, pressure becomes smallest at portions R′ positioned on straight extension lines that extend from the axial center portion O of the reel hub 32 and run orthogonal to straight lines connecting adjacent gates 122, so in thermal constriction after molding (indicated by the hatched portions), these portions constrict the most (L=about 25 μm) and a substantially polygonal hub 210 is formed where the vicinities of the gates 122 become apexes 202.

Consequently, in the present invention, as shown in FIG. 8, in the mold 124 (see FIG. 7) for molding the reel hub 32, the outer peripheral surface 34A of the circular cylinder portion 34 is first formed coaxially with respect to the axial center portion O of the reel hub 32 (r₁=r₂; see FIG. 7), and with respect to the thickness of the circular cylinder portion 34, the portions P positioned on straight lines connecting the axial center portion O of the circular cylinder portion 34 and the gates 122 are made the thinnest, and the portions R positioned on straight extension lines that extend from the axial center portion O of the circular cylinder portion 34 and run orthogonal to straight lines connecting adjacent gates 122 are made the thickest, so that the thickness of the circular cylinder portion 34 is gradually changed.

That is, by gradually thickening the thickness of the circular cylinder portion 34 away from the gates 122, the flow velocity is dropped and the pressure is raised. Thus, constriction of the circular cylinder portion 34 is deterred and the roundness of the circular cylinder portion 34 is obtained. Consequently, according to the present invention, the reel 28 that can ensure the roundness of the circular cylinder portion 34 can be obtained even with multipoint gates.

In the preceding embodiment, a configuration was described where the recording tape cartridge 10 included the leader block 30, but the recording tape cartridge 10 is not limited to this. For example, the recording tape cartridge 10 may have a configuration where a small circular column-shaped leader pin is attached as the leader member to the magnetic tape T or may have a configuration including a shielding member (such as a slide pin that moves along a predetermined straight line or circular arc) that opens and closes the opening 18.

Further, although a configuration was described where the magnetic tape T was used as the recording tape, the recording tape is not limited to this. It suffices as long as the recording tape is understood to be an elongate, tape-like information recording and playback medium with which information can be recorded and recorded information can be played back. It goes without saying that the recording tape cartridge is applicable to all types of recording and playback recording tape.

What is claimed is:

1. A reel comprising:
a bottomed, circular cylinder-shaped hub around which recording tape is wound; and
plural injection portions that are disposed in a bottom surface of the hub, positioned at equidistant intervals along the circumferential direction of the hub, and into which a resin material is injected during molding,
wherein the hub includes a peripheral wall along a circumference whose center coincides with an axial center portion of the hub, and the peripheral wall is thinnest in the vicinities of the injection portions and is thickest in the vicinities of intermediate portions between adjacent injection portions in the circumferential direction of the hub.

2. The reel of claim 1, further comprising a reel plate that is disposed on the bottom surface of the hub and is magnetically attractable to a rotating shaft of a drive device, wherein the injection portions are positioned at equidistant intervals along the circumferential direction of the reel plate outside the reel plate.

3. The reel of claim 1, wherein the vicinities of the injection portions include sites positioned on straight lines connecting the axial center portion of the hub and the injection portions.

4. The reel of claim 1, wherein the vicinities of intermediate portions between adjacent injection portions in the circumferential direction of the hub include sites positioned on straight extension lines that extend in the radial direction from the axial center portion of the hub and run orthogonal to straight lines connecting adjacent injection portions.

5. The reel of claim 1, wherein the thickness of the peripheral wall gradually changes from the injection portion vicinities to the intermediate portion vicinities that are closest.

6. A mold for molding a reel disposed with a hub including a circular cylinder portion around which recording tape is wound and a bottom portion, the mold comprising:
a peripheral surface including an outer surface and an inner surface that demarcate a space for forming the circular cylinder portion; and
plural gates that are positioned at equidistant intervals along the circumferential direction of the peripheral wall in sites for forming the bottom portion and through which a resin material is injected during molding,
wherein a clearance between the outer surface and the inner surface is thinnest at sites adjacent close to the gates and is thickest at sites in the vicinities of intermediate portions between adjacent gates in the circumferential direction.

7. The mold of claim 6, wherein the reel further includes a reel plate that is disposed on the bottom surface of the hub and is magnetically attractable to a rotating shaft of a drive device, and the gates are positioned outside the portion of the site for forming the bottom portion that corresponds to the reel plate.

8. The mold of claim 6, wherein the sites close to the gates include sites positioned on straight lines connecting a site of the mold corresponding to an axial center portion of the hub and the gates.

9. The mold of claim 6, wherein the vicinities of intermediate portions between the gates include sites positioned on straight extension lines that extend in the radial direction from a site of the mold corresponding to an axial center portion of the hub and run orthogonal to straight lines connecting adjacent gates.

10. The mold of claim 6, wherein a clearance between the outer surface and the inner surface gradually changes from sites close to the gates to sites in the vicinities of the intermediate portions that are closest.

11. A reel comprising:
a bottomed, circular cylinder-shaped hub around which recording tape is wound;
a reel plate that is disposed on a bottom surface of the hub and is magnetically attractable to a rotating shaft of a drive device; and
plural gates that are disposed at equidistant intervals along the circumferential direction of the reel plate outside the reel plate and which serve as injection openings for a resin material during molding,
wherein an outer peripheral surface of the hub is formed along a circumference whose center coincides with an axial center portion of the hub, and with respect to the thickness of the hub, first portions positioned on straight lines connecting the axial center portion of the hub and the gates are the thinnest, and second portions positioned on straight extension lines that extend in the radial direction from the axial center portion of the hub and run orthogonal to straight lines connecting adjacent gates are the thickest, so that the thickness of the hub gradually changes toward the second portions.

12. A mold for molding a reel disposed with a bottomed, circular cylinder-shaped hub around which recording tape is wound and a reel plate that is disposed on a bottom surface of the hub and is magnetically attractable to a rotating shaft of a drive device, wherein
plural gates positioned at equidistant intervals along the circumferential direction of the reel plate outside the reel plate and which serve as injection openings for a resin material during molding are disposed, and
a space for forming the hub is configured to include
an outer peripheral surface of the hub along a circumference whose center coincides with an axial center portion of the hub, and
an inner peripheral surface of the hub where first portions positioned on straight lines connecting the axial center portion of the hub and the gates are the thinnest, and second portions positioned on straight extension lines that extend in the radial direction from the axial center portion of the hub and run orthogonal to straight lines connecting adjacent gates are the thickest, so that the thickness of the inner peripheral surface of the hub gradually changes toward the second portions.
